(19) United States
(12) Patent Application Publication
(10) Pub. No.: US 2021/0166715 A1
(43) Pub. Date: Jun. 3, 2021

(54) ENCODED FEATURES AND RATE-BASED AUGMENTATION BASED SPEECH AUTHENTICATION

(71) Applicant: Hewlett-Packard Development Company, L.P., Spring, TX (US)

(72) Inventor: Sunil Bharitkar, Palo Alto, CA (US)

(73) Assignee: Hewlett-Packard Development Company, L.P., Spring, TX (US)

(21) Appl. No.: 16/770,724

(22) PCT Filed: Feb. 16, 2018
(86) PCT No.: PCT/US2018/018492

§ 371 Date: Jun. 8, 2020

(51) Int. Cl. G10L 21/043; G10L 17/04; G10L 17/24; G10L 17/18

(52) U.S. Cl. CPC G10L 21/043; G10L 17/18; G10L 17/24; G10L 17/04

(57) ABSTRACT

In some examples, with respect to encoded features and rate-based augmentation based speech authentication, a plurality of features of a registration speech signal for a user that is to be registered may be extracted. A speech rate of the registration speech signal may be modified to generate a rate-adjusted speech signal, and a plurality of features of the rate-adjusted speech signal may be extracted. The user may be registered by training, based on the plurality of extracted features of the registration speech signal and the plurality of extracted features of the rate-adjusted speech signal, a machine learning model. Further, based on the trained machine learning model, a determination may be made as to whether an authentication speech signal is authentic to authenticate the registered user.

### BACKGROUND

A variety of techniques may be used to authenticate a user's access, for example, to a device, an area, etc. One such technique includes speech authentication. With respect to speech authentication, a user may speak a word or a phrase to gain access to a device (or an area, etc.). The word or phrase spoken by the user may be either accepted or rejected, in which case, the user may be respectively granted or denied access to the device. A variety of factors may impact performance of the speech based authentication. An example of such factors includes ambient noise when the speech based authentication is being utilized. Another example of such factors includes differences in the condition of the user during a registration phase during which the user enrolls with the device for speech authentication, and an authentication (e.g., verification) phase during which the user utilizes the speech authentication feature to gain access to the device. With respect to differences in the condition of the speaker, examples of such differences include how the user speaks, health of the user, etc. Further, another factor that may impact performance of the speech based authentication includes attacks, such as spoofing attacks associated with the device.

### BRIEF DESCRIPTION OF DRAWINGS

Features of the present disclosure are illustrated by way of example and not limited in the following figure(s), in which like numerals indicate like elements, in which:

FIG. 1 illustrates an example layout of an encoded features and rate-based augmentation based speech authentication apparatus;

FIG. 2 illustrates an example layout for speech authentication;

FIG. 3 illustrates further details of the encoded features and rate-based augmentation based speech authentication apparatus of FIG. 1;

FIGS. 4(a)-4(e) respectively illustrate speech from a Hearing in Noise Test (HINT) database, spectral centroid f_{c}, first and second formants f₁ and f₂, corresponding gradients ∇f₁ and ∇f₂, and fundamental frequency f₀ to illustrate operation of the encoded features and rate-based augmentation based speech authentication apparatus of FIG. 1;

FIG. 5 illustrates an example of polynomial-based encoding of the spectral centroid for the male speech from the Hearing in Noise Test database shown in FIG. 4(a) to illustrate operation of the encoded features and rate-based augmentation based speech authentication apparatus of FIG. 1;

FIG. 6 illustrates an example encoded feature set visualization with t-SNE to illustrate operation of the encoded features and rate-based augmentation based speech authentication apparatus of FIG. 1;

FIG. 7 illustrates an example of an authentication analysis to illustrate operation of the encoded features and rate-based augmentation based speech authentication apparatus of FIG. 1;

FIG. 8 illustrates an example block diagram for encoded features and rate-based augmentation based speech authentication;

FIG. 9 illustrates an example flowchart of a method for encoded features and rate-based augmentation based speech authentication; and

FIG. 10 illustrates a further example block diagram for encoded features and rate-based augmentation based speech authentication.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Encoded features and rate-based augmentation based speech authentication apparatuses, methods for encoded features and rate-based augmentation based speech authentication, and non-transitory computer readable media having stored thereon machine readable instructions to provide encoded features and rate-based augmentation based speech authentication are disclosed herein. The apparatuses, methods, and non-transitory computer readable media disclosed herein provide for speech authentication based on the use of features extracted at different speech rates, where the speech may be synthesized artificially, at different rates, to form the basis for speech augmentation to a machine learning model. The original speech and the rate-adjusted speech that may be designated augmented speech may be encoded, prior to training of the machine learning model. Based on the encoding, speech inputs to the machine learning model may include a lower-dimensionality during training (e.g., registration) and authentication phases, while ensuring adequate robustness to speaker condition changes.

Speech recognition may generally encompass verification and identification of a user. For example, automatic speaker verification may be described as the process of utilizing a machine to verify a person's claimed identity from his/her voice. In automatic speaker identification, there may be no a-priori identity claim, and a system may determine who the person is, whether the person is a member of a group, or that the person is unknown. Thus, speaker verification may be described as the process of determining whether a speaker is whom he/she claims to be. Alternatively, speaker identification may be described as the process of determining if a speaker is a specific person or is among a group of persons.

In speaker verification, a person may make an identity claim (e.g., by entering an employee number). In text-dependent recognition, the phrase may be known to the system, and may be fixed or prompted (e.g., visually or orally). A claimant may speak the phrase into a microphone. The signal from the spoken phrase may be analyzed by a verification system that makes a binary decision to accept or reject the claimant's identity claim. Alternatively, the verification system may report insufficient confidence and request additional input before making the decision.

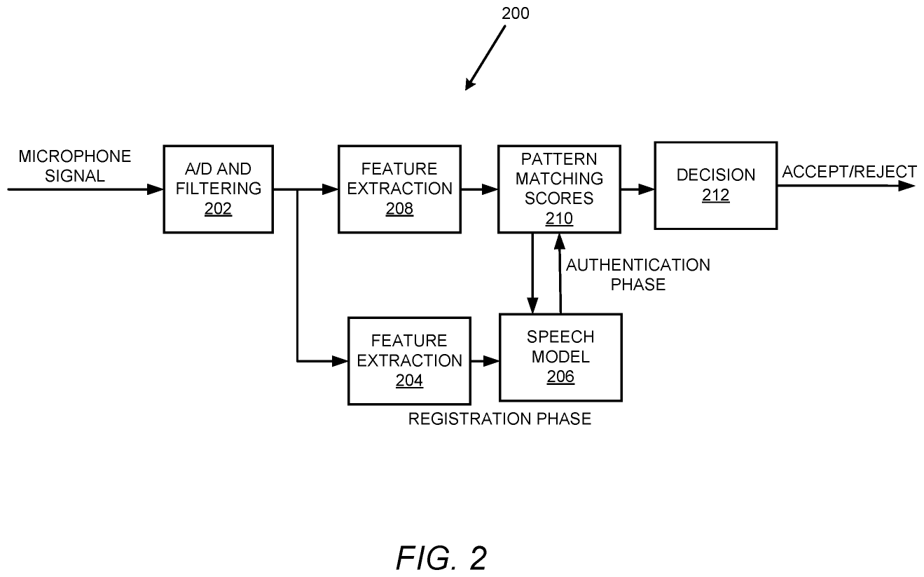

FIG. 2 illustrates an example layout 200 for speech authentication with respect to automated speaker verification. Referring to FIG. 2, the layout 200 may include an initial filtering stage at 202 to perform pre-processing to reduce noise (e.g., via noise suppression) as well as additional voice-activity detection (VAD). During a registration phase, a user may be requested to speak into a microphone a designated (potentially unique) phrase, upon which the subsequent feature extraction process at 204 may be used to extract relevant speech features. From the speech features, a speech model 206 may be derived and used during an authentication (e.g., verification) phase to match against the claimed features. The authentication phase may similarly include a feature extraction process at 208. The pattern match result from the pattern matching scores at 210 may be sent to a decision process at 212 to accept or reject the user. The speech verification technique of FIG. 2 may implement Gaussian Mixture Models and Hidden Markov Models.

The technique of FIG. 2 may include technical challenges in that a user may need to utilize a prescribed phrase for registration and authentication purposes. Further, the user may need to repeat the prescribed phrase multiple times to register. Yet further, the layout of FIG. 2 may not account for differences in the condition of the speaker, where examples of such differences include how the user speaks, the health of the user, etc.

The apparatuses, methods, and non-transitory computer readable media disclosed herein address at least the aforementioned technical challenges of authenticating users who may use a prescribed phrase or an arbitrary speaker-selected phrase during registration. Additionally, if multiple users use the same phrase, the apparatuses, methods, and non-transitory computer readable media disclosed herein may distinguish between such multiple users based on extracted features and the machine learning model disclosed herein. Further, the machine learning model may be trained to accommodate speech rate variations for registered users to build robustness against speech-rate variations. Those users that speak the same phrase as the registered users, but are not registered, may be identified as such and rejected.

In examples described herein, module(s), as described herein, may be any combination of hardware and programming to implement the functionalities of the respective module(s). In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

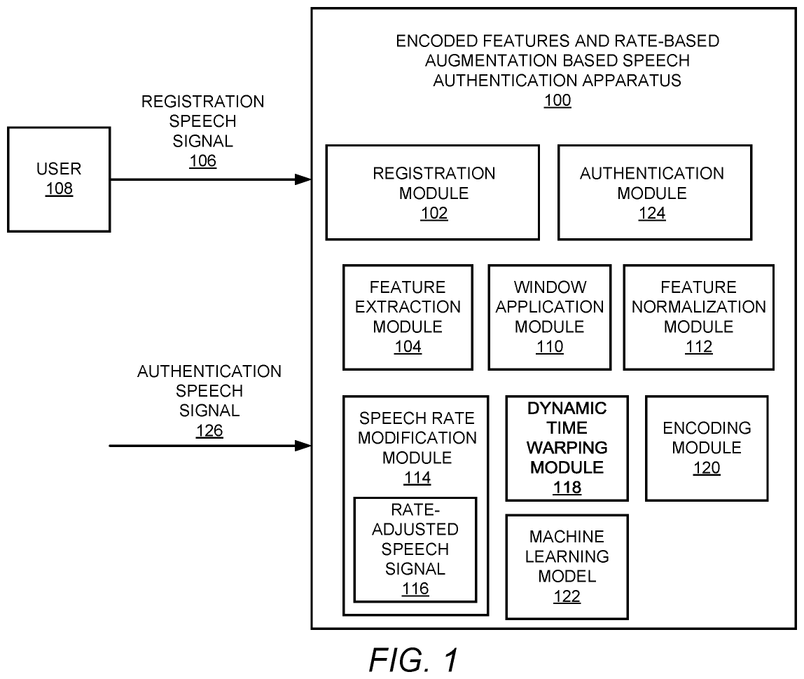

FIG. 1 illustrates an example layout of an encoded features and rate-based augmentation based speech authentication apparatus (hereinafter also referred to as “apparatus 100”).

Referring to FIG. 1, the apparatus 100 may include a registration module 102 that utilizes a feature extraction module 104 to extract a plurality of features of a registration speech signal 106 for a user 108 that is to be registered. According to examples disclosed herein, the feature extraction module 104 may extract the plurality of features that include a spectral centroid f_{c}, a fundamental frequency, first and second formants f₁ and f₂, and corresponding gradients ∇f₁ and ∇f₂.

A window application module 110 may apply a window function to the registration speech signal 106. In this regard, the feature extraction module 104 may extract, based on the application of the window function to the registration speech signal 106, the plurality of features of the registration speech signal 106 for the user 108 that is to be registered.

A feature normalization module 112 may apply feature normalization to the plurality of extracted features of the registration speech signal 106 to remove frames for which activity falls below a specified activity threshold.

A speech rate modification module 114 may modify a speech rate of the registration speech signal 106 to generate a rate-adjusted speech signal 116. In this regard, the speech rate modification module 114 may modify the speech rate of the registration speech signal 106 by p<0% to perform time dilation on the registration speech signal 106 and p>0% to perform time compression on the registration speech signal 106, where p represents a percentage.

The feature extraction module 104 may extract a plurality of features of the rate-adjusted speech signal 116. According to examples disclosed herein, the feature extraction module 104 may extract the plurality of features that include a spectral centroid f_{c}, a fundamental frequency, first and second formants f₁ and f₂, and corresponding gradients ∇f₁ and ∇f₂.

According to examples disclosed herein, the window application module 110 may apply another window function to the rate-adjusted speech signal 116. Further, the feature extraction module 104 may extract, based on the application of the another window function to the rate-adjusted speech signal 116, the plurality of features of the rate-adjusted speech signal 116.

According to examples disclosed herein, the window function applied to the registration speech signal 106 may be identical to the window function applied to the rate-adjusted speech signal 116. For example, the window function may include a Hamming window function, or other such functions.

The feature normalization module 112 may apply feature normalization to the plurality of extracted features of the rate-adjusted speech signal 116 to remove frames for which activity falls below a specified activity threshold.

A dynamic time warping module 118 may perform dynamic time warping between the normalized features of the registration speech signal 106 and the normalized features of the rate-adjusted speech signal 116.

An encoding module 120 may encode, for example, by applying a polynomial encoding function, the normalized features of the registration speech signal 106, the normalized features of the rate-adjusted speech signal 116, and the dynamic time warped features.

The registration module 102 may register the user 108 by training, based on the plurality of extracted features of the registration speech signal 106 and the plurality of extracted features of the rate-adjusted speech signal 116, a machine learning model 122. That is, the registration module 102 may register the user 108 by training, based on the encoded features, the machine learning model 122.

An authentication module 124 may determine, based on the trained machine learning model 122, whether an authentication speech signal 126 is authentic to authenticate the registered user 108. With respect to the authentication performed by the authentication module 124, during registration by the registration module 102, features may be extracted by the feature extraction module 104 from the registration speech signal 106 and the rate-adjusted speech signal 116, where the extracted features may be used to train the machine learning model 122. Similarly, during authentication, the phrase that was used during registration may be used for verification by the authentication module 124 by again extracting features, and utilizing the trained machine learning model 122 to compare to the features extracted during the registration phase.

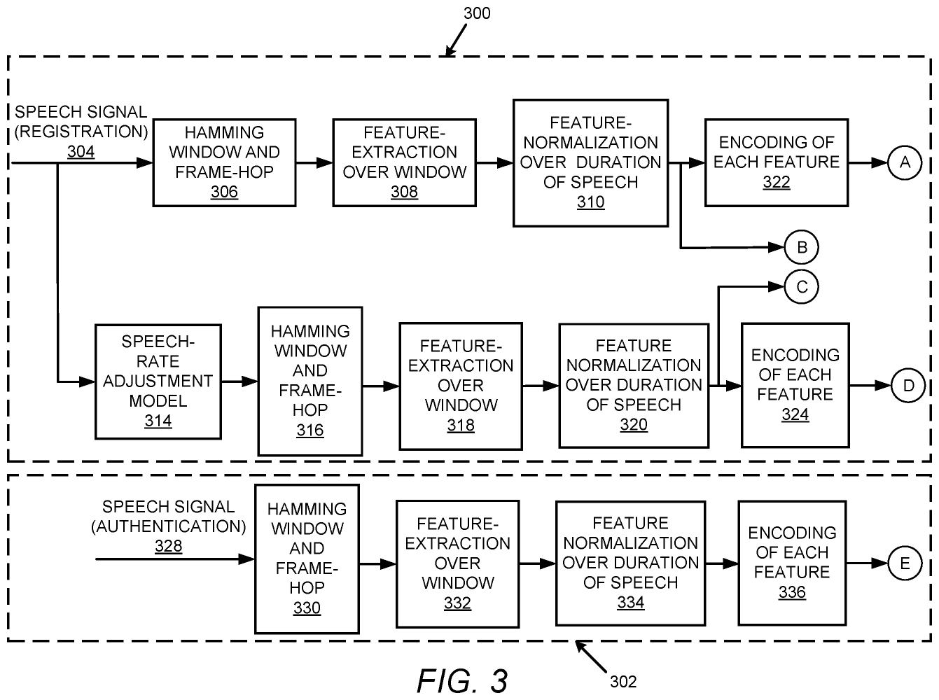

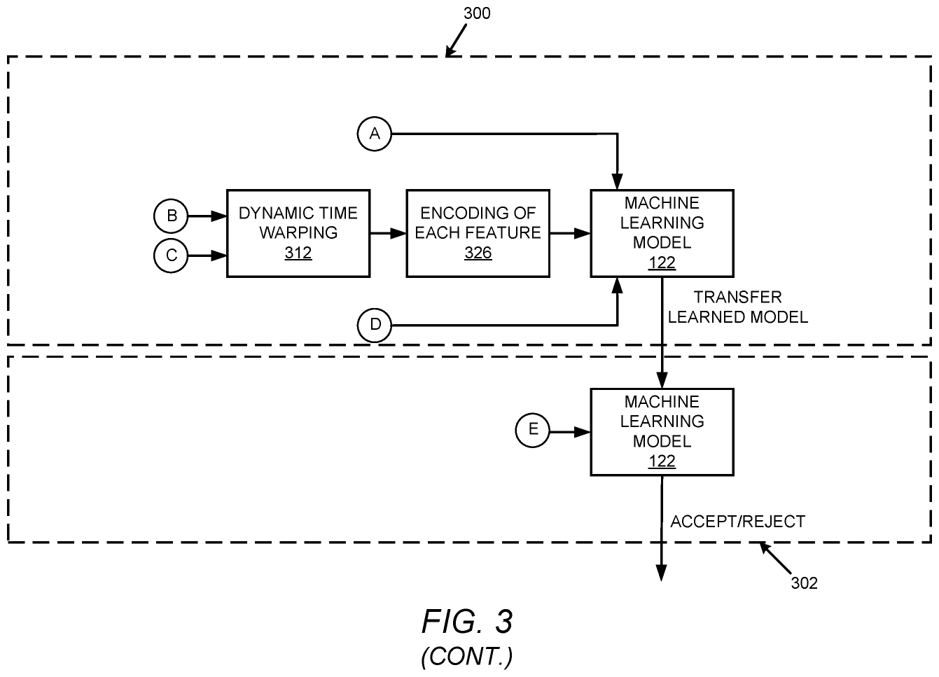

FIG. 3 illustrates further details of the apparatus 100.

Referring to FIGS. 1 and 3, fundamentally, speech authentication involves accepting or rejecting a user's identity claim and may be mapped to a binary classification problem. In this regard, S may be specified as a set of clients, sᵢ∈S may be specified as the i-th user of that set, and x^{(k)} may be specified as a k-th enrollment phrase from a universal set of sentences X. The solution to the authentication problem may be to discover a discriminant function f(x^{(k)}; θ), such that:

f(x^{(k)}, sᵢ;θ)>Δ

f(x^{(qvk)},sⱼ;θ)≥Δ j≠i Equation (1)

For Equation (1), Δ may represent a decision threshold, θ may represent a parameter set used in the optimization of a decision rule for the discriminant function, and V may denote the logical “or” operator for sentences x^{(k)} or x^{(q)}.

For the apparatus 100, speech may be used as input to allow for arbitrary phrases that are registered to be used as authentication by the user 108 accessing, for example, a device, an area, or any system that needs the user 108 to be authenticated. A number of the users may be scalable in that multiple users may access the same device (or area, etc.) with one phrase (e.g., for all users), or different phrases for different users. Further, multiple features may be extracted over the duration of each speech frame in the phrase or sentence.

Area 300 of FIG. 3 may be implemented by the registration module 102 and used during the registration phase. Once the machine learning model 122 has been trained as disclosed herein, area 302 may be implemented by the authentication module 124 and used during authentication (or verification of operation of the apparatus 100).

At 304, during the registration phase, the user 108 may speak a registration phrase once. That is, the registration phrase may be spoken once, instead of the need to speak the registration phrase multiple times. The registration phrase may include any phrase, word, sound, etc., that the user 108 may select for registration, or that may be selected for the user 108 for registration. The registration phrase, when spoken, for example, into a microphone of a device, may be used to generate the registration speech signal 106.

At block 306, each speech frame for the registration speech signal 106 may be Hamming windowed by the window application module 110. For example, each speech frame for the registration speech signal 106 may be Hamming windowed to 512 samples at 16 kHz sample rate (which corresponds to a frame size of 32 ms), and with a hop factor being set to zero (i.e., no-overlap between frames). The technique of block 306 may be adapted to incorporate modifications for different frame-size and hop factors between frames.

At block 308, the feature extraction module 104 may extract, over each windowed frame, features such as spectral centroid f_{c}, fundamental frequency, the first and second formants f₁ and f₂, and the corresponding gradients ∇f₁ and ∇f₂. The spectral centroid f_{c} may represent the frequency-domain weighted average with respect to the registration speech signal 106. The fundamental frequency for the registration speech signal 106 may be estimated using an f₀ frequency estimator. The corresponding gradients ∇f₁ and ∇f₂ for the registration speech signal 106 may indicate the trajectory of the first and second formants, respectively.

The spectral centroid, f_{c}, in a given windowed frame may be determined as follows:

$${f}_{c} = \frac{{\sum }_{k = 1}^{N} {kg}_{k}}{{\sum }_{k = 1}^{N} {g}_{k}} \qquad Equation ( 2 )$$

For Equation (2), gₖ may represent the amplitude response, in the k^{th} frequency bin for a given speech frame of 512 samples, determined using the discrete Fourier transform. The fundamental frequency and the formants may be determined by first determining the linear prediction coefficients (LPC) of order M {aₖ:k=0, 1, . . . M} of the speech frame. A linear prediction coefficients model may represent an all-pole model of the speech signal designed to capture spectral peaks of the speech signal in the windowed speech frame. The linear prediction coefficients model may be determined as follows:

$$A ( z ) = \frac{1}{{\sum }_{k = 0}^{N} {a}_{k} {z}^{- k}} = {\prod }_{k = 1}^{N} \frac{1}{( 1 - {p}_{k} {z}^{- 1} )} \qquad Equation ( 3 )$$

For Equation (3), aₖ may represent coefficients of an autoregressive (AR) model such as linear prediction (LPC), z may represent the complex variable (evaluated on the unit circle it is z=e^{jω}, where ω is the angular frequency), and pₖ may represent the roots of the polynomial described by the expansion of the denominator comprising aₖ.

The fundamental frequency, f₀, may be determined from the roots pₖ of the denominator polynomial in Equation (3) (with z=e^{jω}) from the lowest dominant peak that lies, for example, between 30 Hz and 400 Hz (the average fundamental frequencies for male and female voices may be f̅_{0,male}≈80 Hz, and f̅_{0,female}≈250 Hz) under the constraint that the first and second formants f₁ and f₂ satisfy the following equation:

300<fᵢ<4000 Hz; Δfᵢ<400 Hz (i=1, 2) Equation (4)

For Equation (4), the bandwidth of the formants, Δfᵢ may be determined as follows:

$$idx = \frac{{f}_{x}}{4 π} arctan \frac{Im \{ {p}_{k} \}}{Re \{ {p}_{k} \}} \\ {Δ f}_{i} = - \frac{{f}_{s}}{8 π} log \vert {p}_{idx} \vert \qquad Equation ( 5 )$$

For Equation (5), fₛ may represent the sampling frequency, and idx may represent an index pointing to the roots pₖ previously determined. The gradient for frame m for each formant may be determined by using a first-order difference equation as follows:

∇fᵢ(m)=fᵢ(m)−fᵢ(m−1) Equation (6)

Additional features may be designed for the same captured speech signal during registration, but by changing the speech rate in order to create robustness against speech rate variations which may occur during the subsequent authentication (or verification) stage. The registration speech signal 106 may be rate adjusted by p % (where p=0% is speech at a normal spoken rate, p<0% represents speech at a slower rate than the spoken speech, and p>0% represents speech at a faster rate than the spoken speech). In this regard, p may represent a real number (including integers) describing the time-compression or time-dilation of speech. That is, the registration speech signal 106 may be rate adjusted by p % for time dilation when p<0 (e.g., the rate of the registration speech signal 106 may be slowed down by p %) and time compression when p>0 (e.g., the rate of the registration speech signal 106 may be made faster by p %) for slowing or increasing the speech rate without perceptibly changing the “color” (e.g., any artifacts such as dicks, metallic sounds, or any sounds that make the speech sound unnatural) of the speech signal. According to an example, 0≤|p|≤20, but may be greater than 20.

At block 310, feature normalization may be performed by the feature normalization module 112 which may be applied post feature extraction. The feature normalization may include removing any frame having negligible activity for any of the features (e.g., f_{i,m}=0; ∇f_{j,m}=0; f_{c,m}=0). For example, assuming that “m” represents the frame number, f_{i,m} may represent the i-th formant at frame “m”. For example, if frame “m” includes f_{i,m}=0, then frame “m” may be removed for having negligible activity. Moreover, ∇fᵢ(m)=fᵢ(m)−fᵢ(m−1).

At block 312, with respect to dynamic time warping performed by the dynamic time warping module 118, dynamic time warping may be applied between the features derived from the registration speech signal 106 as well as the features obtained from the rate-adjusted speech signal 116. The dynamic time-warping may provide for the matching of the feature trajectory over time. In this regard, two signals with generally equivalent features arranged in the same order may appear very different due to differences in the durations of their sections. In this regard, dynamic time warping may distort these durations so that the corresponding features appear at the same location on a common time axis, thus highlighting the similarities between the signals. The warped features may serve as augmented data for training the machine learning model 122. Thus, the use of rate-change by the speech rate modification module 114, and the dynamic time warping may ensure that the machine learning model input is made substantially invariant to rate changes of speech so that during authentication, if the user 108 changes the speech rate (e.g., time-dilating or time-compressing certain words), the machine learning model 122 may capture these variances.

At block 314, the speech signal from 304 (i.e., the registration speech signal 106) may be rate adjusted using the speech rate modification module 114, which implements a speech rate adjustment model. The resulting signal may be denoted the rate-adjusted speech signal 116. As discussed above, the registration speech signal 106 may be rate adjusted by p % for time dilation when p<0 and time compression when p>0 for slowing or increasing the speech rate without perceptibly changing the “color” of the speech signal. For example, the registration speech signal 106 may be rate adjusted by p={−20%, 15%, −10%, −5%, 5%, 10%, 15%, 20%}.

At block 316 each speech frame for rate-adjusted speech signal 116 may be Hamming windowed by the window application module 110 similar to block 306. At block 318 the feature extraction module 104 may extract, over each windowed frame, features such as spectral centroid f_{c}, fundamental frequency, the first and second formants f₁ and f₂, and the corresponding gradients ∇f₁ and ∇f₂, similar to block 308. Further, at block 320, feature normalization may be performed by the feature normalization module 112 which may be applied post feature extraction similar to block 310.

Each of the features corresponding to the registration speech signal 106, the rate-adjusted speech signal 116, and the dynamic time warping signals (for all rates), per frame, may then be encoded, respectively, at blocks 322, 324, and 326. With respect to the encoding/smoothing, if the waveform (i.e., speech phrase) is relatively long, the feature vector may become relatively long, and, hence encoding with a low-order fit (e.g., with a polynomial model or other models) may reduce computational needs. The encoding may include the same order for each of the signals. For example, the encoding may be performed by using a polynomial encoding technique to create robustness against fine-scale variations of the input speech features between registering and verification, or noise in the signals. With respect to the encoding, a k^{th} degree polynomial may be expressed as ŷ(x)=Σᵢ₌₀^{k-1}bᵢxⁱ. The residual error in the approximation of yₓ_{ₚ} at p={1, 2, . . . , P} points may be specified as:

$$\begin{matrix}{R}^{2} = {\sum }_{p = 1}^{p} {( y ( {x}_{p} ) - \hat{y} ( {x}_{p} ) )}^{2} \\ = {\sum }_{p = 1}^{p} {( y ( {x}_{p} ) - [ {\sum }_{i = 0}^{k - 1} {b}_{i} {x}_{p}^{i} ] )}^{2}\end{matrix} \qquad Equation ( 7 )$$

For Equation (7), y may represent the desired signal in a frame that is to be approximated (e.g., corresponding to the normalized feature), ŷ may represent the approximation to y, and xₚ may represent the frame index axis. For Equation (7), minimization of R² over the parameter set {bᵢ} may involve obtaining the partials ∂R²/∂bᵢ, ∀i (i.e., for all “i”). In this regard, the solution may be obtained by inverting the Vandermonde matrix V, where

$$V = ( \begin{matrix}1 & {x}_{1} & {… x}_{1}^{k} \\ 1 & {x}_{2} & {… x}_{2}^{k} \\ … & … & … \\ 1 & {x}_{p} & {… x}_{p}^{k}\end{matrix} ) \\ and \\ \underline{b} = {( {V}^{H} V )}^{- 1} {V}^{H} \underline{y} \qquad Equation ( 8 )$$

For Equation (8), b may represent the polynomial coefficient vector.

Conditioning, such as centering and scaling, on the domain xₚ may be performed a-priori to pseudo-inversion to achieve a stable solution. For the example of a 15^{th} order polynomial model, a 16-element polynomial coefficient feature vector may be created over each frame per feature.

The machine learning model 122 of the apparatus 100 is described in further detail.

With respect to the machine learning model 122, the encoded features may be applied as input to a feedforward artificial neural network with Nᵢ input neurons, and one hidden layer with a number of hidden neurons in layer 1 being Nₕ₁=50. The final output layer may be designed flexibly depending on the number of users that need to be authenticated. For example, two output neurons N₀=2 may be used to authenticate (i.e., accept) two different users and reject other users. Examples of techniques that may be utilized for classification may include the Levenberg-Marquardt technique, as well as the gradient descent with momentum and adaptive learning rate technique.

Once the machine learning model 122 with respect to the registration module 102 is trained, as shown in FIG. 3, the machine learning model 122 may be transferred (or otherwise utilized by) to the authentication module 124. As shown at 328 in FIG. 3, the authentication module 124 may receive the authentication speech signal 126 (e.g., {X_{k,m}}). In this regard, at block 330, each speech frame for the authentication speech signal 126 at 328 may be Hamming windowed by the window application module 110 similar to block 306. At block 332 the feature extraction module 104 may extract, over each windowed frame, features such as spectral centroid f_{c}, fundamental frequency, the first and second formants f₁ and f₂, and the corresponding gradients ∇f₁ and ∇f₂, similar to block 308. Further, at block 334, feature normalization may be performed by the feature normalization module 112 which may be applied post feature extraction similar to block 310. At block 336, each of the features corresponding to the speech signal at block 328 may be encoded, similar to block 322. Further, as shown in FIG. 3, the encoded speech signal may be analyzed by the machine learning model 122 to accept or reject the authentication.

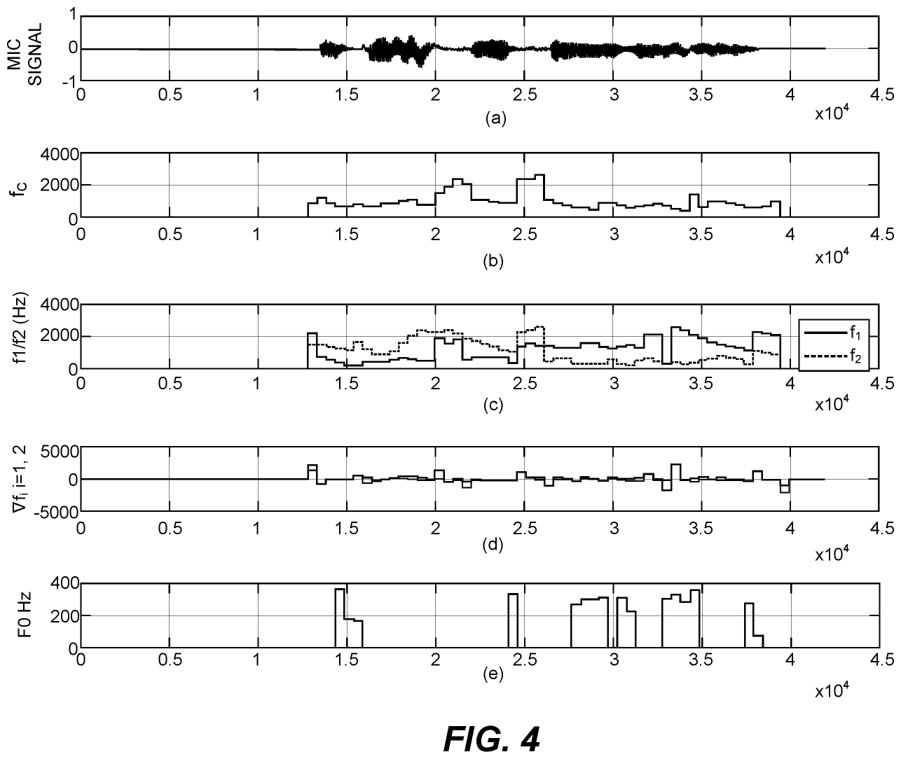

FIGS. 4(a)-4(e) respectively illustrate speech from a Hearing in Noise Test (HINT) database, spectral centroid f_{c}, first and second formants f₁ and f₂, corresponding gradients ∇f₁ and ∇f₂, and fundamental frequency f₀ to illustrate operation of the apparatus 100.

Referring to FIG. 4(a), the speech signal may represent the spoken phrase for a male user 108 as “A toy fell from the window.” Encoded features as disclosed herein with respect to FIG. 3 may be used to train the machine learning model 122. In one example, the machine learning model 122 may utilize gradient descent with momentum and adaptive learning rate as training functions. In other examples, the training functions may include conjugate gradient, Levenberg-Marquardt, and other such training functions. Further, the input data for the machine learning model 122 may be randomly shuffled, for example, using Monte Carlo simulation.

For the example of FIG. 4, the machine learning model 122 may include one hidden layer with 50 neurons (i.e., Nₕ₁=50) with Nᵢ=96 input neurons for [symbol] ^{96×1} dimensional encoded feature vector (16 polynomial coefficients per feature, with 6 features).

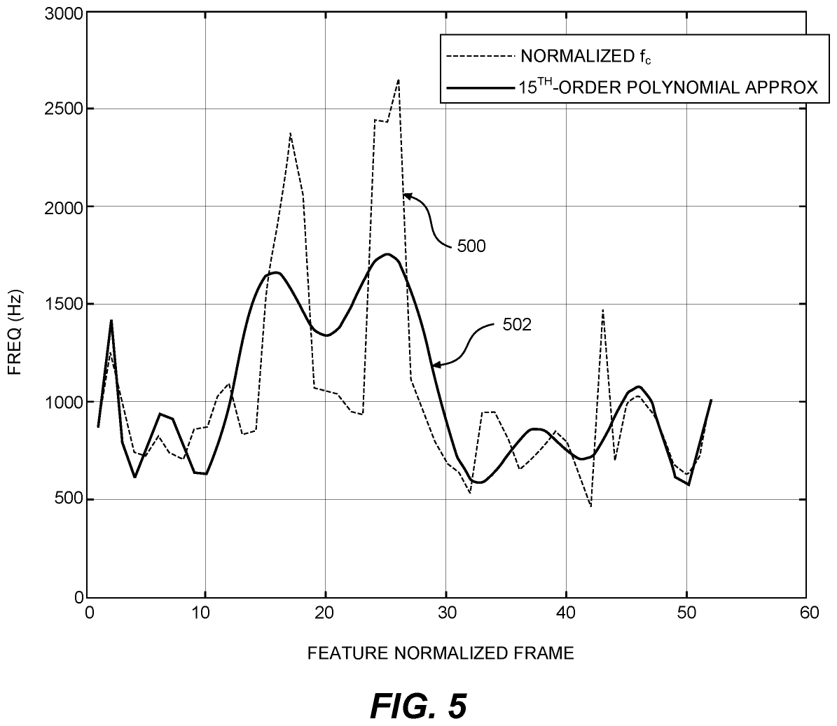

FIG. 5 illustrates an example of polynomial-based encoding of the spectral centroid for the male speech from the Hearing in Noise Test database shown in FIG. 4(a) to illustrate operation of the apparatus 100.

Referring to FIG. 5, an example of the feature normalized output for the spectral centroid, and its 15^{th} order polynomial encoded approximation, is shown. In this regard, FIG. 5 shows the result of applying polynomial encoding of 15^{th} order to the spectral centroid over the speech duration (after feature normalization which includes isolating low spectral centroids where there is no speech between words) for the same male speech, with the curve at 500 showing spectral centroid and the curve at 502 showing the polynomially encoded results). Additionally, for the example of FIGS. 4(a)-4(e), the machine learning model 122 may be trained to authenticate a second female speech signal with the same phrase “A toy fell from the window”. In this regard, the classifier may be designed to provide a binary class representation at the output for the Nₒ=2 output neurons (i.e., male speech trained to be classified with oₘₐₗₑ={1, −1} and o_{female}={−1, 1}). The training set may include 50 encoded feature-vectors per class (e.g., with the two classes, the training size may be specified as 100). The M_{training}=ΣᵢMᵢ=25 per class may be derived as: encoded feature vector associated with the original speech (i.e., M₁=1), feature-vectors from rate adjusted p as in FIG. 3 (i.e., M₂=8), and dynamic time warping based encoded feature vectors for all combinations of p relative to p=0 (M₃=16).

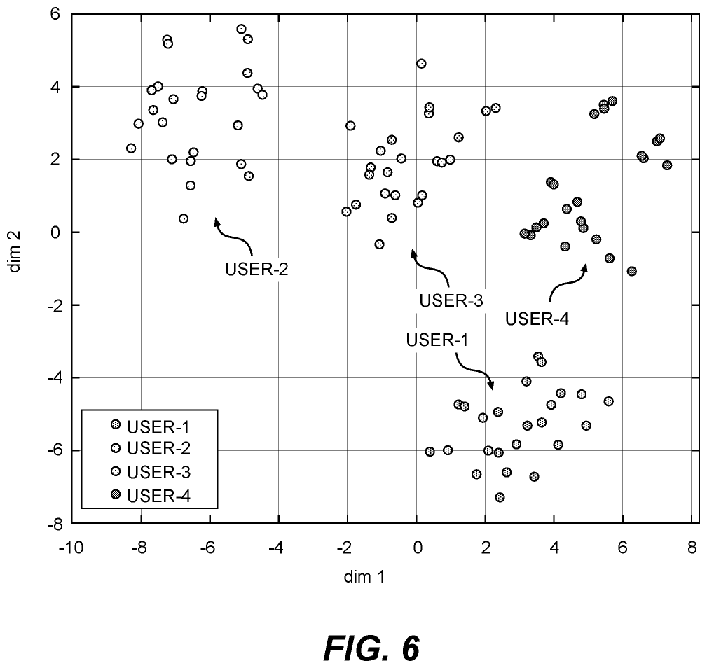

In order to test operation of the apparatus 100, the classification accuracy for the male and female Hearing in Noise Test signals with speech may be rate-adjusted such that 0<p<20 and p {±5%, ±10%, ±15%, ±20%}, and further, speech at different rates may be recorded from four users (e.g., users (1) to (4)) with the same phrase, giving a total of six different speech sources (including two from the Hearing in Noise Test database). In this regard, listening assessments may be performed at various speech rates to ensure naturalness. Further, FIG. 6 illustrates an example encoded feature set visualization with t-distributed stochastic neighbor embedding (t-SNE) to illustrate operation of the apparatus 100. The t-SNE may represent a t-distributed stochastic neighbor embedding (t-SNE) is a machine learning technique for dimensionality reduction. Referring to FIG. 6, the features with respect to users (1) to (4) are shown clustered appropriately with low overlap to allow the machine learning model 122 to perform with high accuracy and robustness.

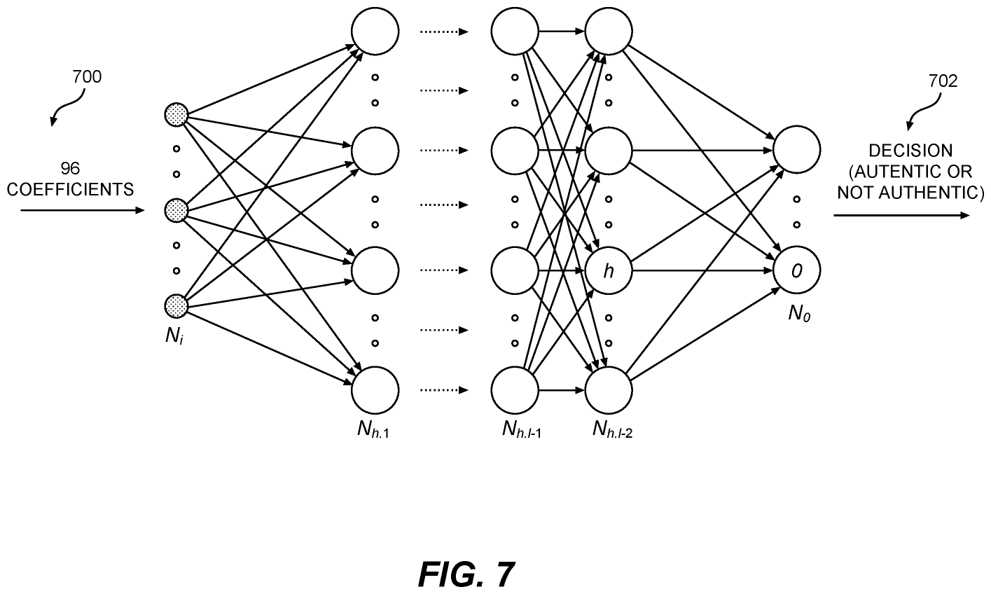

FIG. 7 illustrates an example of an authentication analysis to illustrate operation of the apparatus 100.

Referring to FIG. 7, the machine learning model 122 is illustrated as including 96 coefficients that may be received as input at 700 to generate a decision at 702. The decision may include an indication of whether the authentication speech signal 126 is authentic or not authentic. For the machine learning model 122, with respect to the example of FIGS. 4-6, each of the 16th order coefficients for the 6 features used (f_{c}, f₁, f₂, f₀, ∇f₁, and ∇f₂) may be delivered to the machine learning model 122, which in the example of FIG. 7 represents a feed-forward neural network of adequate capacity (i.e., not deep) having two hidden-layers (the first one with 20 neurons and second one with 10 neurons). The machine learning model 122 may be trained with two output-neurons for two-classes (male and female users, respectively). Thus the machine learning model 122 may be trained to identify the same phrases from the users used for training from the registration phase.

The apparatus 100 may thus provide for automated speech verification for multiple trained users and rejection of unauthorized users for speech phrases at various speaking rates.

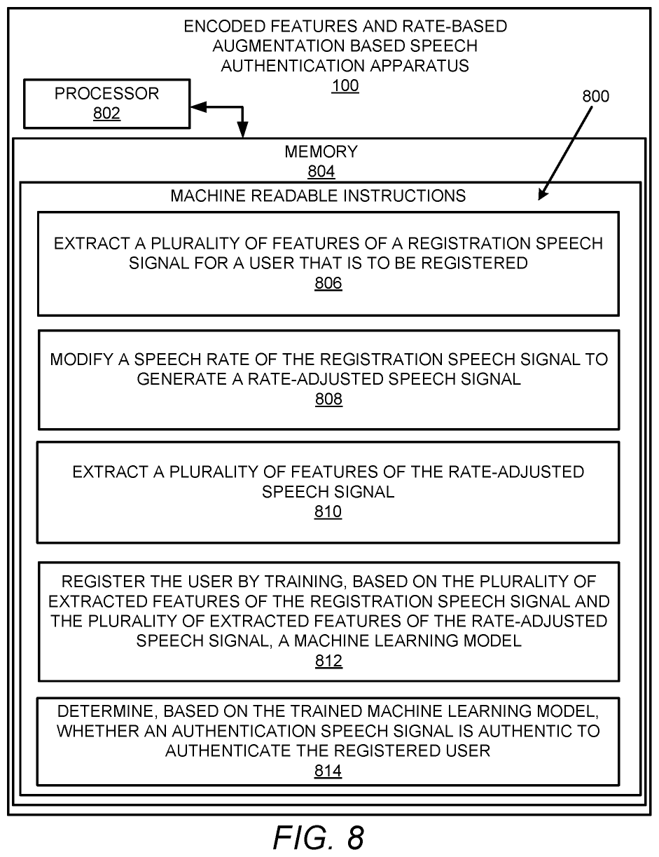

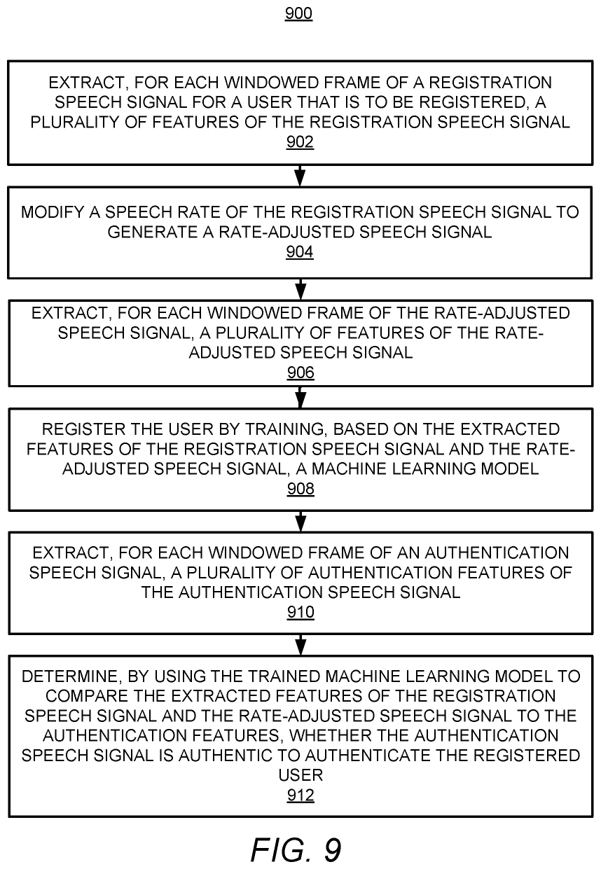

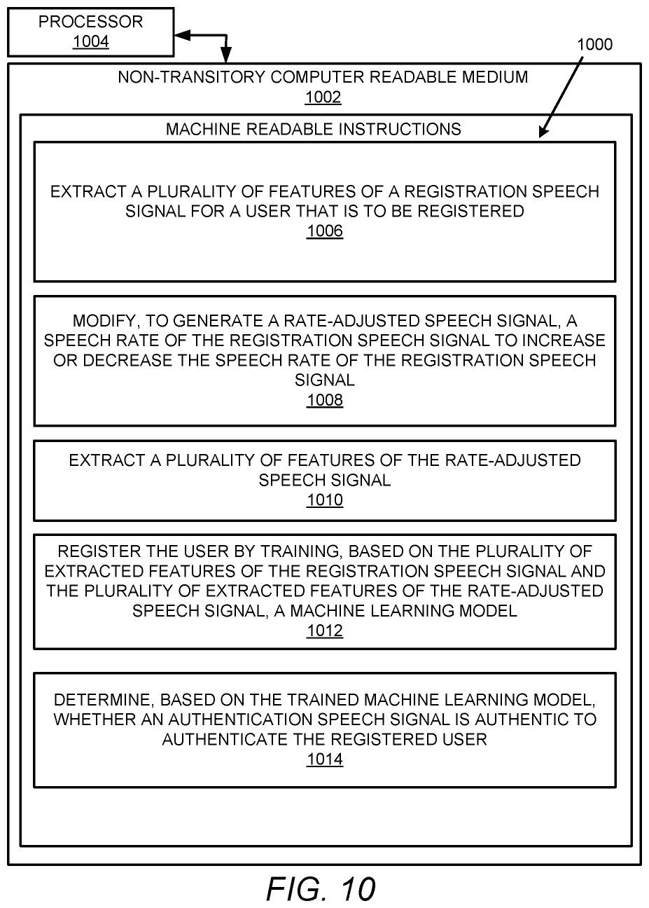

FIGS. 8-10 respectively illustrate an example block diagram 800, an example flowchart of a method 900, and a further example block diagram 1000 for encoded features and rate-based augmentation based speech authentication. The block diagram 800, the method 900, and the block diagram 1000 may be implemented on the apparatus 100 described above with reference to FIG. 1 by way of example and not limitation. The block diagram 800, the method 900, and the block diagram 1000 may be practiced in other apparatus. In addition to showing the block diagram 800, FIG. 8 shows hardware of the apparatus 100 that may execute the instructions of the block diagram 800. The hardware may include a processor 802, and a memory 804 (i.e., a non-transitory computer readable medium) storing machine readable instructions that when executed by the processor 802 cause the processor to perform the instructions of the block diagram 800. The memory 804 may represent a non-transitory computer readable medium. FIG. 9 may represent a method for encoded features and rate-based augmentation based speech authentication. FIG. 10 may represent a non-transitory computer readable medium 1002 having stored thereon machine readable instructions to provide encoded features and rate-based augmentation based speech authentication. The machine readable instructions, when executed, cause a processor 1004 to perform the instructions of the block diagram 1000 also shown in FIG. 10.

The processor 802 of FIG. 8 and/or the processor 1004 of FIG. 10 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 1002 of FIG. 10), such as hardware storage devices (e.g., RAM (random access memory), ROM (read only memory), EPROM (erasable, programmable ROM), EEPROM (electrically erasable, programmable ROM), hard drives, and flash memory). The memory 804 may include a RAM, where the machine readable instructions and data for a processor may reside during runtime.

Referring to FIGS. 1-8, and particularly to the block diagram 800 shown in FIG. 8, the memory 804 may include instructions 806 to extract a plurality of features of a registration speech signal 106 for a user 108 that is to be registered.

The processor 802 may fetch, decode, and execute the instructions 808 to modify a speech rate of the registration speech signal 106 to generate a rate-adjusted speech signal 116.

The processor 802 may fetch, decode, and execute the instructions 810 to extract a plurality of features of the rate-adjusted speech signal 116.

The processor 802 may fetch, decode, and execute the instructions 812 to register the user 108 by training, based on the plurality of extracted features of the registration speech signal 106 and the plurality of extracted features of the rate-adjusted speech signal 116, a machine learning model 122.

The processor 802 may fetch, decode, and execute the instructions 814 to determine, based on the trained machine learning model 122, whether an authentication speech signal 126 is authentic to authenticate the registered user 108.

Referring to FIGS. 1-7 and 9, and particularly FIG. 9, for the method 900, at block 902, the method may include extracting, for each windowed frame of a registration speech signal 106 for a user 108 that is to be registered, a plurality of features of the registration speech signal 106.

At block 904 the method may include modifying a speech rate of the registration speech signal 106 to generate a rate-adjusted speech signal 116.

At block 906 the method may include extracting, for each windowed frame of the rate-adjusted speech signal 116, a plurality of features of the rate-adjusted speech signal 116.

At block 908 the method may include registering the user 108 by training, based on the extracted features of the registration speech signal 106 and the rate-adjusted speech signal 116, a machine learning model 122.

At block 910 the method may include extracting, for each windowed frame of an authentication speech signal 126, a plurality of authentication features of the authentication speech signal 126.

At block 912 the method may include determining, by using the trained machine learning model 122 to compare the extracted features of the registration speech signal 106 and the rate-adjusted speech signal 116 to the authentication features, whether the authentication speech signal xxx is authentic to authenticate the registered user 108.

Referring to FIGS. 1-7 and 10, and particularly FIG. 10, for the block diagram 1000, the non-transitory computer readable medium 1002 may include instructions 1006 to extract a plurality of features of a registration speech signal 106 for a user 108 that is to be registered.

The processor 1004 may fetch, decode, and execute the instructions 1008 to modify, to generate a rate-adjusted speech signal 116, a speech rate of the registration speech signal 106 to increase or decrease the speech rate of the registration speech signal 106.

The processor 1004 may fetch, decode, and execute the instructions 1010 to extract a plurality of features of the rate-adjusted speech signal 116.

The processor 1004 may fetch, decode, and execute the instructions 1012 to register the user by training, based on the plurality of extracted features of the registration speech signal 106 and the plurality of extracted features of the rate-adjusted speech signal 116, a machine learning model 122.

The processor 1004 may fetch, decode, and execute the instructions 1014 to determine, based on the trained machine learning model 122, whether an authentication speech signal 126 is authentic to authenticate the registered user 108.

What has been described and illustrated herein is an example along with some of its variations. The terms, descriptions and figures used herein are set forth by way of illustration and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium storing machine readable instructions that when executed by the processor cause the processor to:
extract a plurality of features of a registration speech signal for a user that is to be registered;
modify a speech rate of the registration speech signal to generate a rate-adjusted speech signal;
extract a plurality of features of the rate-adjusted speech signal;
register the user by training, based on the plurality of extracted features of the registration speech signal and the plurality of extracted features of the rate-adjusted speech signal, a machine learning model; and
determine, based on the trained machine learning model, whether an authentication speech signal is authentic to authenticate the registered user.

2. The apparatus according to claim 1, wherein the instructions to extract the plurality of features of the registration speech signal for the user that is to be registered, and extract the plurality of features of the rate-adjusted speech signal are further to cause the processor to:
apply a window function to the registration speech signal;
extract, based on the application of the window function to the registration speech signal, the plurality of features of the registration speech signal for the user that is to be registered.
apply another window function to the rate-adjusted speech signal; and
extract, based on the application of the another window function to the rate-adjusted speech signal, the plurality of features of the rate-adjusted speech signal.

3. The apparatus according to claim 2, wherein the window function applied to the registration speech signal is identical to the window function applied to the rate-adjusted speech signal.

4. The apparatus according to claim 1, wherein the instructions to extract the plurality of features of the registration speech signal for the user that is to be registered are further to cause the processor to:
extract the plurality of features that include a spectral centroid f_{c}, a fundamental frequency, first and second formants f₁ and f₂, and corresponding gradients ∇f₁ and ∇f₂.

5. The apparatus according to claim 1, wherein the instructions to extract the plurality of features of the rate-adjusted speech signal are further to cause the processor to:
extract the plurality of features that include a spectral centroid f_{c}, a fundamental frequency, first and second formants f₁ and f₂, and corresponding gradients ∇f₁ and ∇f₂.

6. The apparatus according to claim 1, wherein the instructions are further to cause the processor to:
apply feature normalization to the plurality of extracted features of the registration speech signal and the plurality of extracted features of the rate-adjusted speech signal to remove frames for which activity falls below a specified activity threshold.

7. The apparatus according to claim 6, wherein the instructions are further to cause the processor to:
perform dynamic time warping between the normalized features of the registration speech signal and the normalized features of the rate-adjusted speech signal.

8. The apparatus according to claim 7, wherein the instructions to register the user by training, based on the plurality of extracted features of the registration speech signal and the plurality of extracted features of the rate-adjusted speech signal, the machine learning model are further to cause the processor to:
encode, by applying a polynomial encoding function, the normalized features of the registration speech signal, the normalized features of the rate-adjusted speech signal, and the dynamic time warped features; and
register the user by training, based on the encoded features, the machine learning model.

9. The apparatus according to claim 1, wherein the instructions to modify the speech rate of the registration speech signal to generate the rate-adjusted speech signal are further to cause the processor to:
modify the speech rate of the registration speech signal by p<0% to perform time dilation on the registration speech signal and p>0% to perform time compression on the registration speech signal, where p represents a percentage.

10. A computer implemented method comprising:
extracting, for each windowed frame of a registration speech signal for a user that is to be registered, a plurality of features of the registration speech signal;
modifying a speech rate of the registration speech signal to generate a rate-adjusted speech signal;
extracting, for each windowed frame of the rate-adjusted speech signal, a plurality of features of the rate-adjusted speech signal;
registering the user by training, based on the extracted features of the registration speech signal and the rate-adjusted speech signal, a machine learning model;
extracting, for each windowed frame of an authentication speech signal, a plurality of authentication features of the authentication speech signal; and
determining, by using the trained machine learning model to compare the extracted features of the registration speech signal and the rate-adjusted speech signal to the authentication features, whether the authentication speech signal is authentic to authenticate the registered user.

11. The method according to claim 10, further comprising:
applying feature normalization to the plurality of extracted features of the registration speech signal and the plurality of extracted features of the rate-adjusted speech signal to remove frames for which activity falls below a specified activity threshold.

12. The method according to claim 11, further comprising:
performing dynamic time warping between the normalized features of the registration speech signal and the normalized features of the rate-adjusted speech signal.

13. The method according to claim 12, wherein registering the user by training, based on the extracted features of the registration speech signal and the rate-adjusted speech signal, the machine learning model, further comprises:
encoding, by applying a polynomial encoding function, the normalized features of the registration speech signal, the normalized features of the rate-adjusted speech signal, and the dynamic time warped features; and
registering the user by training, based on the encoded features, the machine learning model.

14. A non-transitory computer readable medium having stored thereon machine readable instructions, the machine readable instructions, when executed, cause a processor to:
extract a plurality of features of a registration speech signal for a user that is to be registered;
modify, to generate a rate-adjusted speech signal, a speech rate of the registration speech signal to increase or decrease the speech rate of the registration speech signal;
extract a plurality of features of the rate-adjusted speech signal;
register the user by training, based on the plurality of extracted features of the registration speech signal and the plurality of extracted features of the rate-adjusted speech signal, a machine learning model; and
determine, based on the trained machine learning model, whether an authentication speech signal is authentic to authenticate the registered user.

15. The non-transitory computer readable medium according to claim 14, wherein the machine readable instructions to extract the plurality of features of the registration speech signal for the user that is to be registered, when executed, further cause the processor to:
extract the plurality of features that include a spectral centroid f_{c}, a fundamental frequency, first and second formants f₁ and f₂, and corresponding gradients ∇f₁ and ∇f₂.
